(19) United States
(12) Patent Application Publication
(10) Pub. No.: US 2003/0018780 A1
(43) Pub. Date: Jan. 23, 2003

(54) Method and apparatus for managing network devices

(76) Inventor: Masanori Kawashima, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/173,631

(22) Filed: Jun. 19, 2002

(30) Foreign Application Priority Data
Jun. 26, 2001 (JP) 193558/2001

(51) Int. Cl. G06F 15/173

(52) U.S. Cl. 709/224

(57) ABSTRACT

This disclosure relates to an apparatus which notifies the user of the state of a network device using an e-mail message as needed even when no response is acquired from the network device. A response request command is sent to the network device at a predetermined timing, and the response state of the network device to the response request command is stored. The previous response state is read out from a storage component (S801), and it is checked if a response is received (S802). If a response is received, it is also checked if a response is received in the current process (S803). If no response is received in the current process, an e-mail message indicating that no response is received from the device is generated (S804), and is sent (S807). On the other hand, if a response is returned from the device which returned no response in the previous process (S805), an e-mail message indicating that the device has been recovered is generated (S804), and is sent (S807).

### FIELD OF THE INVENTION

This invention relates to a technique for managing various network devices connected to a computer network and, more particularly, to a method and apparatus for managing network devices, and a management program.

### BACKGROUND OF THE INVENTION

Networking in an office or the like is advancing by interconnecting a plurality of computers via a LAN (local area networks). The LAN not only can network a plurality of computers arranged on one floor of a building, but also can network a large number of computers within the entire building, a building group (on the premises), and an area, or beyond the border between countries. Furthermore, LANs can be connected to form a larger network, and can often be connected to the Internet or the like. Not only computers but also various information processing devices such as printers and the like are connected to the LAN. In this way, since a plurality of information processing devices are connected to the LAN, management is required in correspondence with the scale of the LAN.

In case of a small-scale LAN such as SOHO (small office home office) or the like, the user himself or herself can replace a device by another, install software, and diagnose problems. It is not particularly necessary to strictly maintain and manage the network by a system administrator or the like.

However, in a LAN with a complicated arrangement or a large-scale LAN group formed by interconnecting a large number of LANs, extension/removal of devices, updating of software, trouble monitoring, and the like must be done constantly. Hence, sophisticated “management” is required. Note that “management” here means both that by a network administrator and that by software and hardware that the network administrator uses. In the present specification, “management” particularly means that by software used to manage the entire system. Also, “user” means a person who uses network device management software. This user is normally a system administrator. The user can acquire management data from various devices connected on the network and can change the management data using the network device management software. In all types of networks, management such as maintenance or the like is required to smoothly run the network.

Hence, a device monitoring module implemented by software periodically acquires status data from devices to be managed at predetermined cycles, and when the contents of the acquired status data indicate abnormality, an e-mail message indicating that abnormality has occurred in a given device to be managed is generated and is sent to the user.

However, in such related art, whether the device is abnormal or normal is determined based on the contents of the acquired status data. For this reason, if no response is returned from the device to be managed, it is determined that there is no device to be checked, i.e., no abnormality occurs in the device to be managed, and no e-mail message is generated.

In this connection, the device to be managed does not return any response in response to a status inquiry when serious abnormalities have occurred, e.g., (1) when the power supply of the device to be managed is OFF, (2) when the network cable of the device to be managed is unplugged, and (3) some fatal abnormality has occurred in the device to be managed. Therefore, it presents a problem if such abnormal state cannot be identified.

### SUMMARY OF THE INVENTION

According to the present invention, the foregoing object is attained by providing an apparatus for managing one or more network devices connected to a network, comprising a sending component for sending a response request command to the network device at a predetermined timing, a detection component for detecting a change in response state of the network device in response to the response request command, and a message sending component for sending a message corresponding to a detection result of the detection component to a predetermined message address when the detection component detects a change in response state.

It is another object of the present invention to provide an apparatus for managing one or more network devices connected to a network, comprising a sending component for sending a response request command to the network device at a predetermined timing, a receiving component for receiving response information when the network device sends the response information in response to the response request command, a checking component for checking if the receiving component receives the response information, a message generation component of generating a message corresponding to the checking result of the checking component to a predetermined mail address, and a message sending component for sending the message generated by the message generation component.

According to a first aspect of the present invention, when no response is acquired from a given device to be managed, a message indicating that no response is acquired from the device to be managed can be sent to an address which is set in advance. For example, a message indicating that a serious problem has occurred in the device to be managed, e.g., (1) the power supply of the device is OFF, (2) the network cable of the device is unplugged, or (3) some fatal abnormality has occurred in the device, can be sent to an administrator or service person.

According to a second aspect of the present invention, when a response from the device to be managed is recovered, a message indicating that a response from the device to be managed is recovered can be sent to an address which is set in advance. For example, the administrator or service person who received the message indicating that no response is acquired from the device to be managed can be prevented from wasting time to confirm the state of the device to be managed, the response from which has already been recovered.

Furthermore, according to a third aspect, using an information acquisition process implemented by a device monitoring module of general network device management software, the presence/absence of a response from the device to be managed can be checked. Hence, no additional information acquisition request need be issued to only check the presence/absence of a response from the device to be managed, and the traffic on the network and the load on the device to be managed can be reduced. An information acquisition request or response information tailored to the present invention can be defined upon practicing the present invention.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the network arrangement according to a common embodiment;

FIG. 2 is a chart showing the MIB structure;

FIG. 3 is a perspective view showing a printer to which a network board on which an agent is installed is connected;

FIG. 4 is a block diagram showing the electrical connections among the network board, printer, and LAN;

FIG. 5 is a block diagram showing the arrangement of a PC on which network device management software can run;

FIG. 6 is a block diagram showing the module configuration of the network device management software;

FIG. 7 is a flow chart showing a device response status monitoring process according to a common embodiment;

FIG. 8 is a flow chart showing a device response status notification process according to the first embodiment;

FIG. 9 shows an example of a mail message sent when no device response is acquired;

FIG. 10 shows an example of a mail message sent when a response from the device has been recovered;

FIG. 11 is a flow chart according to the second embodiment;

FIG. 12 is a flow chart according to the third embodiment; and

FIG. 13 shows a memory map of a CD-ROM as an example of a storage medium that stores a program of the present invention.

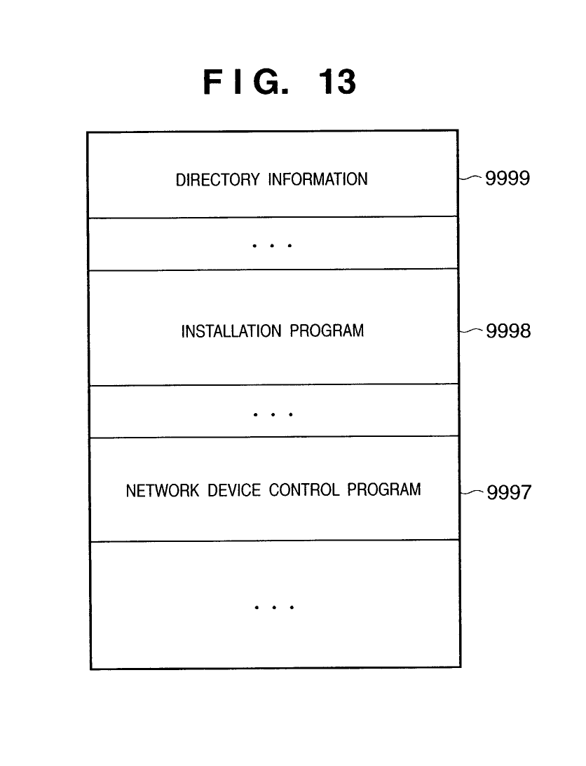

### DETAILED DESCRIPTION OF THE PREFERRED EMBODIMENTS

Preferred embodiments of the present invention will now be described in detail in accordance with the accompanying drawings.

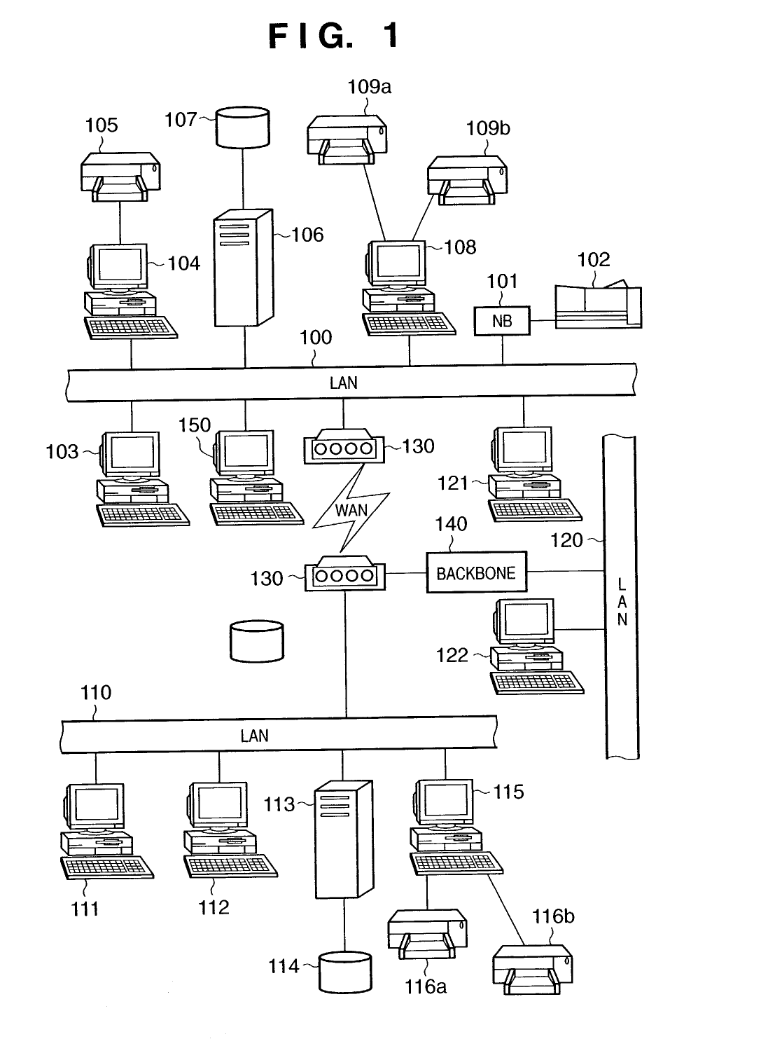

An example of a large-scale network that requires management will be explained below. FIG. 1 shows a state wherein an NB (network board) 101 is connected to a printer 102 with an open architecture. The NB 101 is connected to a LAN 100 via a LAN interface such as an Ethernet interface 10Base-2 having a coaxial connector, 10Base-T having RJ-45, or the like.

PCs (personal computers) 103, 104, and the like are also connected to the LAN 100. Under the control of a network operating system, these PCs can communicate with the NB 101. One of the PCs, e.g., the PC 103, can be designated as a network administrator. Also, a printer such as a printer 105 connected to the PC 104 may be connected to each PC.

A file server 106 is connected to the LAN 100. A large-size network disk 107 is connected to the file server 106. The network disk 107 stores a plurality of files. When the PCs access these files, the file server 106 manages such accesses. A print server 108 controls printers 109a and 109b, a remote printer 105, and the like to print. An e-mail server 117 has a role of collecting and delivering e-mail messages. When the user who has an e-mail address establishes connection to the e-mail server from a client such as the PC 103, 104, or the like, the e-mail server 117 sends an e-mail message sent from that user to another e-mail server, or distributes e-mail messages delivered from other e-mail servers to respective users. Other peripheral devices (not shown) may be connected to the LAN 100.

More specifically, the network shown in FIG. 1 can use network software such as an OS available from Novell, Inc., UNIX OS, or the like. The present invention does not depend on a specific network software but can use any network software. For example, the present invention uses Netware (a tradename of Novell, Inc.; the same applies to the following description) available from Novell, Inc. Please refer to an on-line documentation that comes with a Netware package for a detailed explanation of this software package. This is available from Novell, Inc., together with the Netware package.

To explain briefly, the file server 106 serves as a file manager upon executing exchange, storage, queuing, caching, and the like of data files among LAN members. For example, data files respectively created by the PCs 103 and 104 are sent to the file server 106, which sorts these files in a given order, and sends the sorted data files to the printer 109a in accordance with a command from the print server 108.

Each of the PCs 103 and 104 is a personal computer, which generates a data file, sends the generated data file via the LAN 100, receives a file via the LAN 100, and displays the file. FIG. 1 illustrates personal computers, but other computer devices which execute network software may be included. For example, if network software is a UNIX OS, a UNIX workstation is connected to the network as another computer device.

Normally, the LAN 100 or the like provides services to a somewhat local user group such as a user group present on one floor or a plurality of successive floors in a given building. On the other hand, if user groups are also present in other buildings or other prefectures, a WAN (wide area network) may be formed. The WAN is basically an aggregation formed by connecting several LANs via a digital line such as ISDN (Integrated Services Digital Network) or the like. FIG. 1 shows an example of the WAN. The LAN 100 and LANs 110 and 120 are interconnected via MODEM (modulator/demodulator)/routers 130 and backbone 140 to form a WAN. These connections are simple electrical connections using several buses.

The LAN may include a file server, print server, and e-mail server, which are not always required. Therefore, as shown in FIG. 1, the LAN 110 includes PCs 111 and 112, a file server 113, a network disk 114, a print server 115, and printers 116a and 116b. In contrast, the LAN 120 includes only PCs 121 and 122. Devices connected to the LANs 110 and 120 can access functions of other LAN devices via WAN connections.

As a method of managing devices on such large-scale networks, some attempts have been made so far in many standard organizations. For example, ISO (International Organization for Standardization) has proposed a versatile reference framework called an OSI (Open Systems Interconnection) model. The OSI model of a network management protocol is called CMIP (Common Management Information Protocol). CMIP is a common network management protocol in Europe.

In the U.S.A., a variation of CMIP called SNMP (Simple Network Management Protocol) is present as a network management protocol with higher commonality. Please refer to M. T. Rose, Takeshi Nishida (TR), “Practical Management: An introduction to Management of TCP/IP-based Internets”, Toppan Printing. Co., Ltd., Aug. 20, 1992 (First Edition) for a detailed discussion of SNMP. According to the SNMP network management technique, a network management system includes at least one network management station, nodes to be managed, agents equipped on nodes to be managed, and a network management protocol that the network management station and agents use to exchange management information. The user can acquire and change data on the network via communications with agent software on each node to be managed using network device management software on the network management station.

The agent is software which runs as a background process for each target device. When the user requests a device on the network to send management data, management software sets object identification information in a management packet or frame, and outputs that packet or frame to a target agent. The agent interprets that object identification information to extract data corresponding to the object identification information, sets that data in a packet, and sends the packet back to the user. In some cases, a corresponding process may be called to extract data.

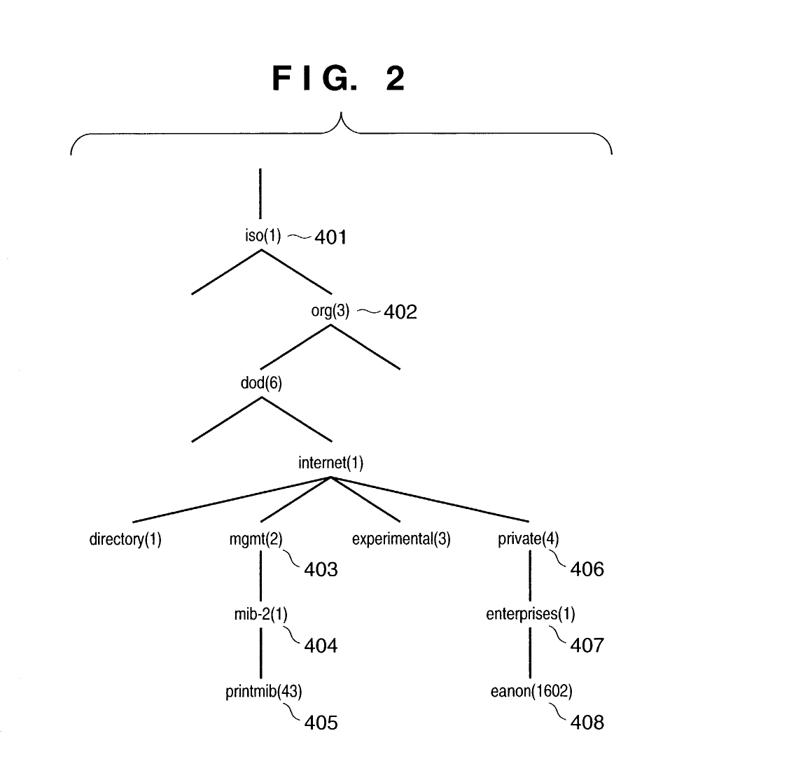

The agent holds data associated with its status in the form of a database. This database is called an MIB (management information base). FIG. 2 shows the structure of the MIB. As shown in FIG. 2, the MIB has a tree data structure, and all nodes are uniquely assigned numbers. In FIG. 2, a number written in parentheses is an identifier of that node. For example, the identifier of a node 401 in FIG. 2 is “1”. The identifier of a node 402 is expressed by “1.3” since it is “3” below the node 401. Likewise, the identifier of a node 403 is expressed by “1.3.6.1.2”. This node identifier is called an object identifier. This MIB structure is called an SMI (Structure and identification of Management Information), and is specified by RFC1155 “Structure and Identification of Management Information for TCP/IP-based Internets”.

FIG. 2 shows only some of MIBs specified as standards. A node 404 is called a standard MIB, which is a top-most node of an object group. The standard MIB is an object group normally equipped in a device to be managed by SNMP. The detailed structure of objects located below the node 404 is specified by RFC1213 “Management Information Base for Network Management of TCP/IP-based Internets: MIB-II”.

A node 405 is called a printer MIB, which is a top-most node of an object group. The printer MIB is an object group normally equipped in a printer to be managed by SNMP. The detailed structure of objects located below the node 405 is specified by RFC1759 “Printer MIB”.

Furthermore, a node 406 is called a private MIB, which is a top-most node upon making private MIB definition by an enterprise, organization, or the like. A node 407 is called an enterprise extended MIB, which is a top-most node upon making private extension in private MIBs by an enterprise. For example, an enterprise ID “1602” is assigned to a given enterprise to make private definition, and a top-most node 408 used to define MIBs unique to this enterprise is located below the node 407 as that which means the enterprise. The object identifier of the top-most node of private enterprise MIBs is “1.3.6.1.4.1.1602”.

As an installation example of the agent, the agent may be installed on a network board used to connect a printer to the network. In this manner, the printer can be set as a device to be managed by the network device management software. The user acquires information of the printer to be controlled and can change status data using the network device management software. More specifically, the user can acquire a character string displayed on a liquid crystal display of the printer, and can change a default paper feed cassette.

An embodiment in which the NB (network board) on which the agent is installed is connected to the printer will be explained below.

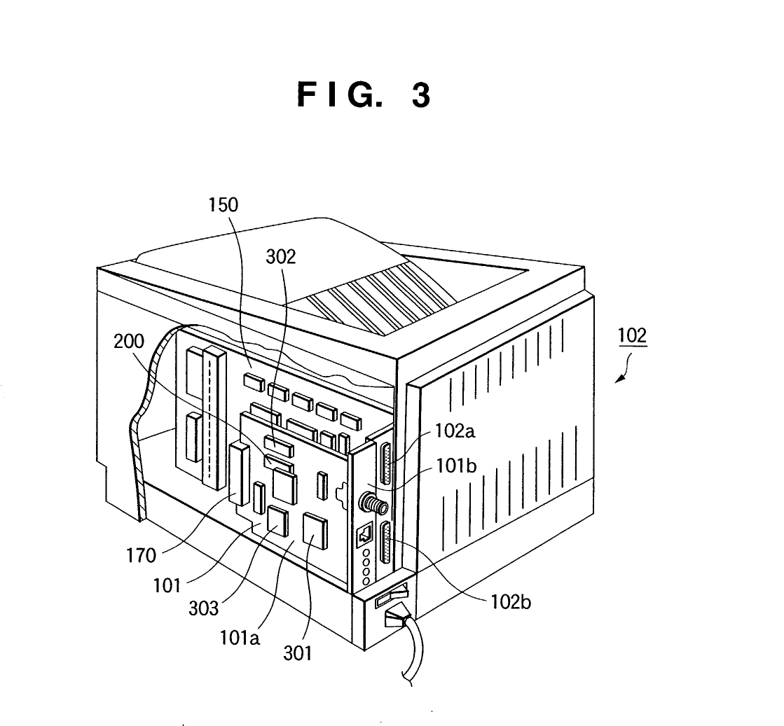

FIG. 3 is a sectional view showing a state wherein the NB 101 is installed in the printer 102. As shown in FIG. 3, the NB 101 comprises a printed circuit board 101a having a face plate 101b for network connection, and is connected to a printer interface card 150 via a connector 170. The printer interface card 150 directly controls a printer engine of the printer 102. Print data and a print status command are input from the NB 101 to the printer interface card 150 via the connector 170, and printer status information is acquired from the printer interface card 150 via the connector 170. The NB 101 communicates this information on the LAN 100 via a network connector of the face plate 101b. At the same time, the printer 102 can receive print data from a conventional serial port 102a and parallel port 102b.

As shown in FIG. 3, the NB 101 is preferably inserted in an internal extended I/O slot of the printer 102, and serves as a “built-in” network node that comprises a processing function to be described below and a data storage function.

With the arrangement of the NB 101, characteristic auxiliary functions of supervising and managing a large multi-area WAN network can be provided. These auxiliary functions include a printer control function from a remote place (e.g., an office of a network supervisor) on the network, a status observation function, an automatic management function of the printer arrangement that provides a guaranteed initial environment to the next user after each print job, a function of accessing via the network to characterize the load amount on the printer or to set an exchange schedule of toner cartridges, and a function of recording a printer log or use statistic.

It is important in NB design to implement a function of accessing a printer control function from the NB 101 via a two-way interface such as a shared memory 200 or the like. In addition to the shared memory, an interface such as a SCSI interface or the like can be used. In this way, printer operation information can be output to the NB 101 or an external network node. Furthermore, a large number of convenient auxiliary function programs are executed based on this printer information. Print image data and control information blocks are generated by a microprocessor 301 on the NB 101, are written in the shared memory 200, and are then loaded by the printer 102. Likewise, printer status information is sent from the printer 102 to the shared memory 200, and is read by the microprocessor 301 on the NB from the memory 200.

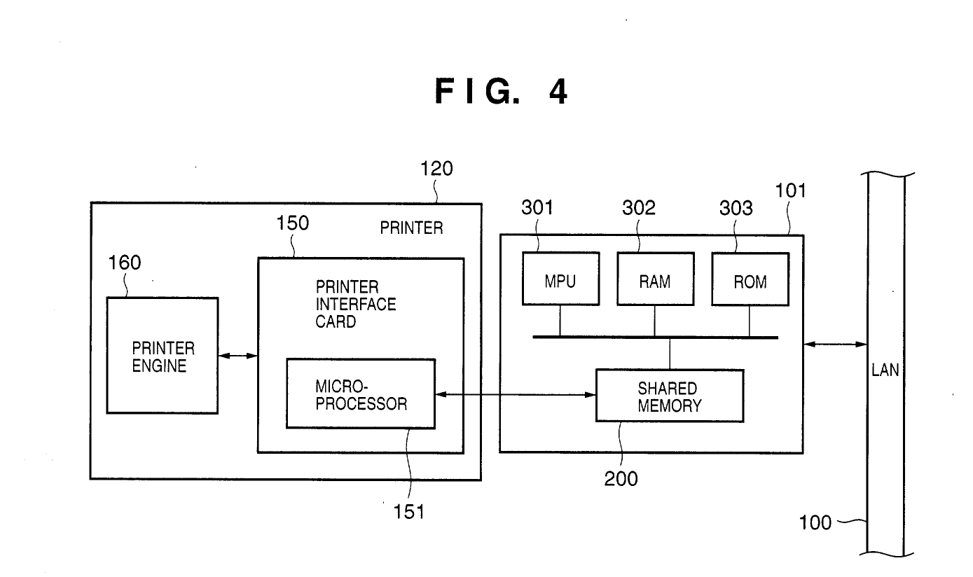

FIG. 4 is a block diagram showing the electrical connections among the NB 101, printer 102, and LAN 100. The NB 101 is directly connected to the LAN 100 and printer 102 via a LAN interface and the printer interface card 150, respectively. On the NB 101, the microprocessor 301 for controlling the NB 101, a ROM 303 for storing an operation program of the microprocessor 301, a RAM 302 used as a work area of the microprocessor 301 upon executing the program, and the shared memory 200 used to exchange data between the NB 101 and printer interface card 150 are mounted, and are interconnected via an internal bus. A program which makes the NB 101 operate as an SNMP agent is stored in the ROM 303. The microprocessor 301 operates according to the program stored in the ROM 303, and uses the RAM 302 as a work area. Also, the microprocessor 301 uses the shared memory 200 as a buffer area upon communicating with the printer interface card 150.

A microprocessor 151 on the printer interface card 150 makes data accesses with the NB 101 via the shared memory 200 arranged on the NB 101. The microprocessor 151 on the printer interface card 150 also communicates with a printer engine 160 which actually drives a print mechanism.

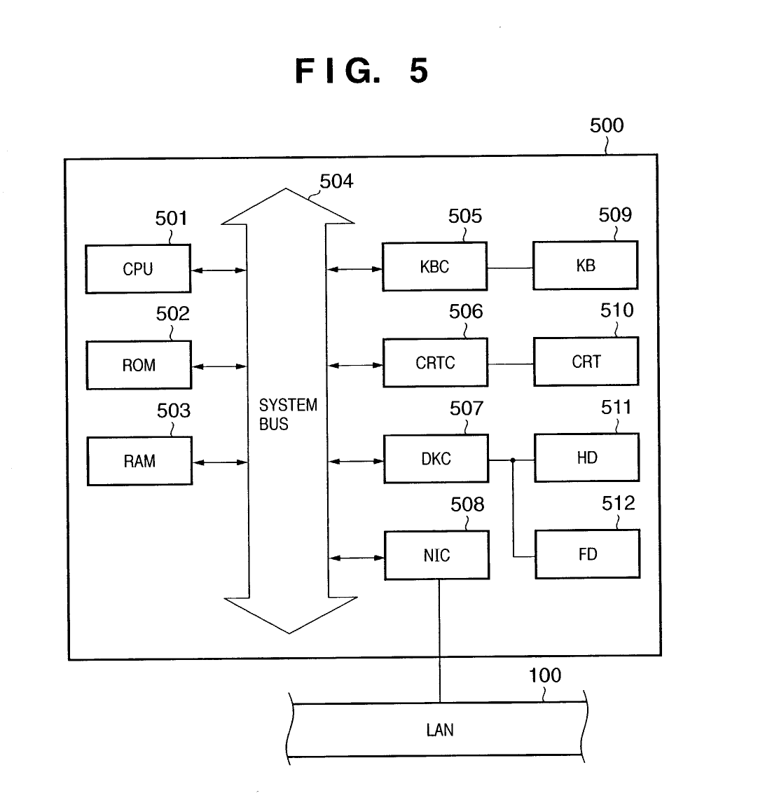

A PC on which network device management software runs will be explained below using FIG. 5. FIG. 5 is a block diagram showing the arrangement of a PC on which the network device management software can run.

Referring to FIG. 5, reference numeral 500 denotes a PC on which the network device management software runs, and the PC 500 is equivalent to the PC 103 in FIG. 1. The PC 500 comprises a CPU 501 which executes a network management program stored in a ROM 502 or HD (hard disk) 511, or supplied from an FD (floppy disk drive) 512, and systematically controls respective devices connected to a system bus 504.

Reference numeral 503 denotes a RAM which serves as a main memory, work area, and the like of the CPU 501. Reference numeral 505 denotes a KBC (keyboard controller) for controlling instruction inputs from a KB (keyboard) 509, a pointing device (not shown), and the like. Reference numeral 506 denotes a CRTC (CRT controller) for controlling display on a CRT (CRT display) 510. Reference numeral 507 denotes a DKC (disk controller) for controlling accesses to the HD 511 and FD 512 which store a boot program, various applications, edit files, user files, network management program, and the like. Reference numeral 508 denotes an NIC (network interface card) which exchanges data in two ways with the agent or network device via the LAN 100.

The configuration of the network device management software of the present invention will be described below.

A network management apparatus of the present invention is implemented by launching network device management software on the PC shown in FIG. 5. The HD 511 stores a program of the network device management software, which forms an operation agent (to be described later) together with the CPU 501. In all the following descriptions, the execution agent on hardware is the CPU 501 unless otherwise specified. On the other hand, a control agent on software is network device management software stored in the HD 511. In this embodiment, Windows (available from Microsoft Corp.) is assumed as an OS, but the present invention is not limited to such specific OS.

Note that the network management program according to the present invention may be supplied in the form of a storage medium such as a floppy disk, CD-ROM, or the like, which stores the program. In this case, the program is read by the FD 512 shown in FIG. 5, a CD-ROM drive (not shown), or the like, and is installed in the HD 511.

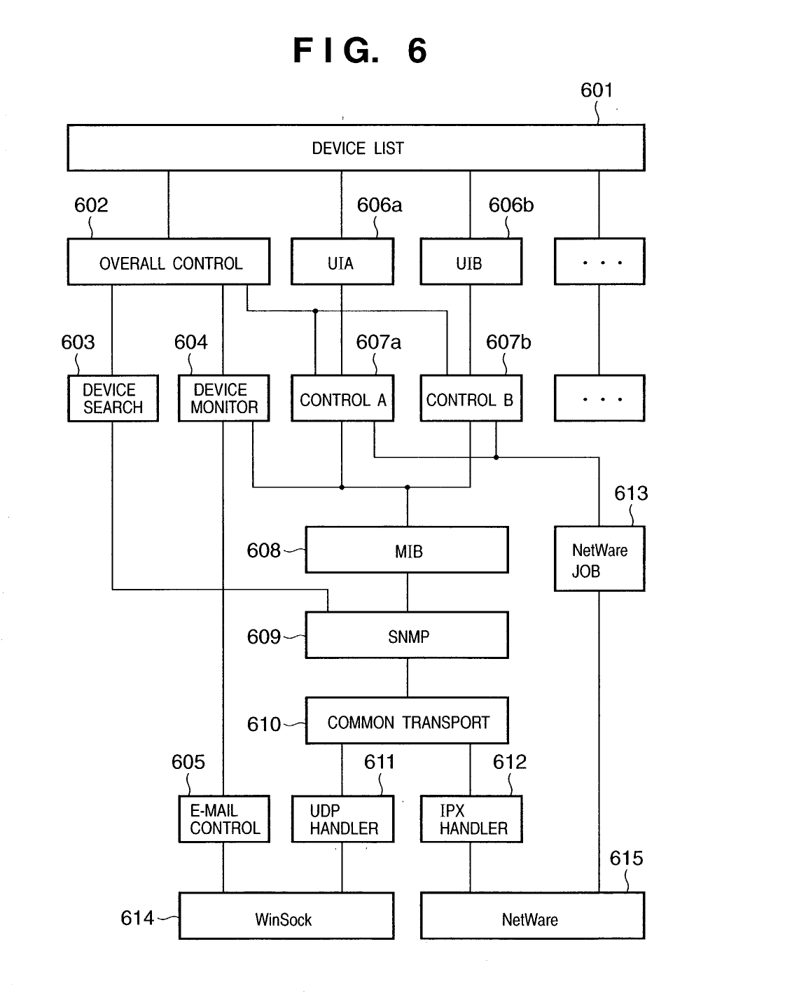

FIG. 6 shows the module configuration of the network device management software according to an embodiment of the present invention. The network device management software according to the present invention is stored in the HD 511 shown in FIG. 5, and is executed by the CPU 501. In this case, the CPU 501 uses the RAM 503 as a work area.

Referring to FIG. 6, reference numeral 601 denotes a device list module which provides a user interface that, e.g., displays a list of network devices connected to the network. The device list module 601 issues a processing request to an overall control module 602 (to be described later) or displays other user interfaces such as a UI A606a, UIB606b, and the like (to be described later) in accordance with a user's instruction. Also, the device list module 601 comprises a user interface used to switch a protocol for searching for network devices, and to select a search range of network devices and devices to be managed in addition to the function of displaying a list of network devices.

Reference numeral 602 denotes an overall control module which supervises lower-order modules (to be described below) in accordance with a request from the device list module 601.

Reference numeral 603 denotes a device search module for searching for network devices connected to the network. In an example of the device search method, on the network to which the PC installed with the network device management software is connected, an SNMP search module 609 (to be described later) broadcasts a GetRequest packet to predetermined MIB objects, a network device that received the GetRequest packet sends a GetResponse Packet, and the SNMP search module 609 of that PC receives this PCGetResponse packet. The device list module 603 displays a list of network devices found by the device search module 603.

Reference numeral 604 denotes a device monitoring module which monitors the state of a specific network device (to be referred to as a device to be managed hereinafter) selected by the device list module 601. When an abnormality has occurred in the state of a given device to be managed, the device monitoring module 604 generates an e-mail message that notifies the contents of that abnormality, and sends that message to an address which is set in advance. The state of a device to be managed is normally acquired by inquiring about the value of an appropriate MIB object that indicates the state of the device to be managed using a GetRequest packet. For example, in case of a network printer which installs private MIBs of a given enterprise, whether or not an abnormality (out of paper, paper jam, cassette open, out of toner, or the like) has occurred in the printer can be determined by acquiring the value of an MIB object which indicates the state of the printer.

Reference numeral 605 denotes an e-mail control module which sends the e-mail message generated by the device monitoring module 604 to an address which is set in advance. The e-mail control module 605 converts the contents of the e-mail message passed from the device monitoring module 604 into a format of predetermined e-mail data, and sends the e-mail data to the e-mail server 117 via WinSock 614 (to be described later).

Reference numerals 606a and 606b denote UI modules (UI A and UI B), each of which provides a user interface used to display and set detailed information of a specific network device when that network device is selected from the list of network devices displayed by the device list module 601. FIG. 6 illustrates only two UI modules, i.e., UI A 606a and UI B 606b. However, in practice, dedicated UI modules are prepared in correspondence with the types of network devices compatible to the network device management software.

Reference numerals 607a and 607b denote control modules, each of which makes control unique to a device required to display and set detailed information of a specific network device. The control module depends on the UI module.

Reference numeral 608 denotes an MIB module which converts an object key designated from a higher-order module into an object identifier. Note that the object key is a 32-bit integer which has one-to-one correspondence with an object identifier. The object identifier is a variable-length identifier. However, as it is troublesome to process such a variable-length identifier upon implementing the network device management software, a fixed-length identifier which has one-to-one correspondence with the object identifier is internally used in the network device management software according to the present invention. Higher-order modules of the MIB module 608 process MIB information using the object keys. In this manner, it becomes easy to implement the network device management software.

Reference numeral 609 denotes an SNMP module which sends/receives SNMP packets (GetRequest, GetNextRequest, SetRequest, Trap).

Reference numeral 610 denotes a common transport module which absorbs the difference from a lower-order protocol used to transport SNMP data. In practice, either module of a UPD handler 611 or IPX handler 612 serves to transfer data in accordance with a protocol of user's choice upon operation. Note that the UPD handler 611 is implemented by WinSock 614, and the IPX handler 612 is implemented by Netware 615. Please refer to, e.g., the specification “Windows Socket API v1.1” for the WinSock 614. This document is available from a plurality of locations, and comes with “Microsoft Visual C/C++” as a compiler available from Microsoft Corp. Please refer to, e.g., “NetWare Programmer's Guide for C” published by Novell, Inc. This book is available from Novell, Inc.

Reference numeral 613 denotes a NetWare job module which acquires status data of a print job from the network server using the Netware 615.

The operation of the network device management software as an embodiment of the present invention will be described in detail below using the accompanying drawings.

In all the following descriptions, the execution agent on hardware is the CPU 501, and the control agent on software is network device management software installed in the HD 511 unless otherwise specified. Also, a combination of the NB 101 connected to the network in FIG. 1, and the printer 102 on which that network board is mounted is called a network device.

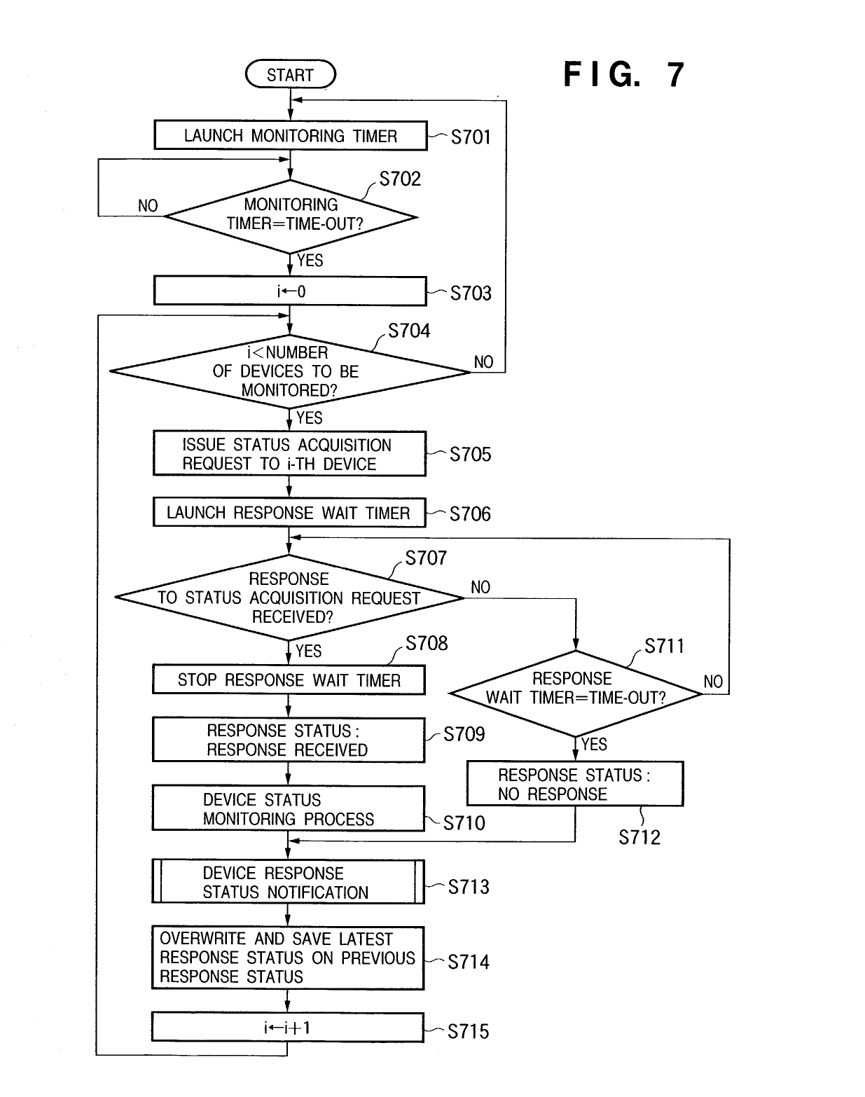

FIG. 7 is a flow chart showing an example of a device status monitoring process in an embodiment of the network device management software of the present invention.

Note that this process is started upon launching the network device management software, and is ended upon quitting the network device management software. In this embodiment, assume that the user interface implemented by the device list module 601 and used to designate a device to be managed sets devices to be managed in advance, and a list of devices to be managed saved on the HD 511 is loaded onto a work area on the RAM 503 in an indexing-allowable format upon launching the network device management software.

Referring to FIG. 7, a timer for measuring a time interval upon acquiring status data from devices to be managed (to be referred to as a monitoring timer hereinafter) is launched in step S701, and the flow advances to step S702. It is checked in step S702 if the monitoring timer launched in step S701 has reached time-out. If the timer has reached time-out, the process advances to step S703 (step S702: Yes); otherwise, the flow returns to step S702 (step S702: No). In step S703, a variable i used to index a device to be managed is reset to zero, and the flow advances to step S704. In step S704, the value of the variable i is compared with the number of devices to be managed. If the value of the variable i is smaller than the number of devices to be managed, the flow advances to step S705 (step S704: Yes); otherwise, the flow returns to step S701 (step S704: No).

In step S705, a status inquiry request of the i-th device to be managed is issued (information acquisition step), and the flow advances to step S706. In this embodiment, a GetRequest packet used to acquire an MIB object which indicates the state of the device to be managed is sent. In step S706, a time for measuring a response wait time from the device to be managed in response to the status inquiry request issued in step S705 (to be referred to as a response wait timer hereinafter) is launched, and the flow advances to step S707.

It is checked in step S707 if a response is returned from the i-th device to be managed in response to the status inquiry request issued in step S705. If a response is returned, the flow advances to step S708 (step S707: Yes); otherwise, the flow advances to step S711 (step S707: No). In this embodiment, the presence/absence of a response from the device to be managed is determined by checking if a GetResponse packet is received from the device to be managed. In step S708, the response wait timer launched in step S706 for the i-th device to be managed is stopped, and the flow advances to step S709. In step S709, data indicating that a response is returned from the i-th device to be managed in response to the current information acquisition request is recorded on a work area on the RAM 503 (response status holding step), and the flow advances to step S710.

In step S710, a general device monitoring process for the latest state of the i-th device to be managed is executed, and the flow advances to step S713. A detailed description of the device monitoring process executed in this step will be omitted. For example, this process includes a process for sending an e-mail message to an address which is set in advance when the status data of the device to be managed indicates an abnormality.

It is checked in step S711 if the response wait time launched for the i-th device to be managed in step S706 has reached time-out. If the timer has reached time-out, the flow advances to step S712 (step S711: Yes); otherwise, the flow returns to step S707 (step S711: No). In step S712, data indicating that no response is received from the i-th device to be managed in response to the current information acquisition request is recorded on the work area on the RAM 503 (response status holding step), and the flow advances to step S713.

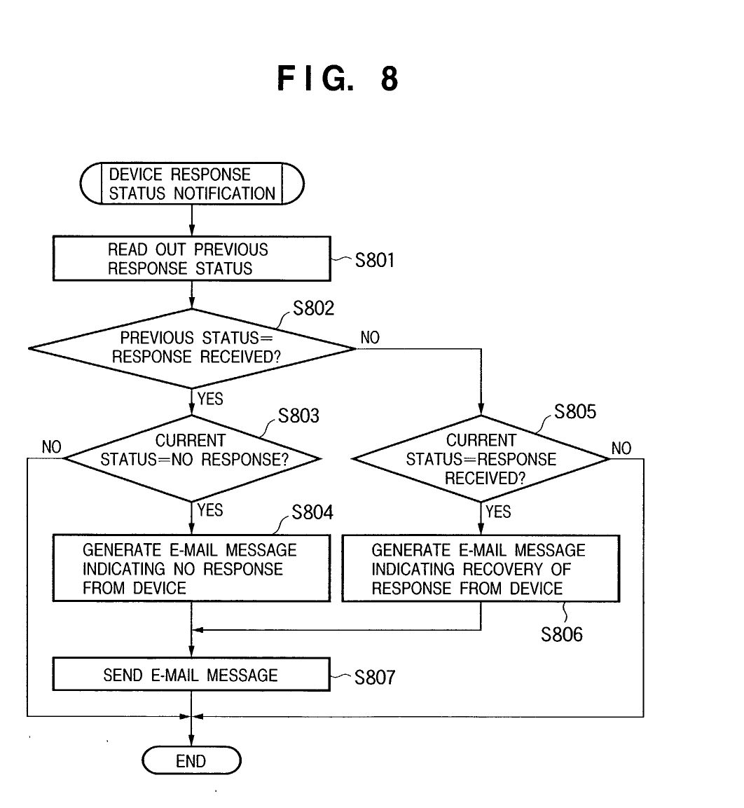

In step S713, a device response status notification process shown in FIG. 8 (to be described later) is executed for the i-th device to be managed, and the flow advances to step S714. In step S714, the presence/absence of a response to the latest information acquisition request, which is stored in the work area on the RAM 503 in step S709 or S712 is overwritten on the presence/absence of a response to the immediately preceding information acquisition request, which is saved on the RAM 503 (response status holding step), and the flow advances to step S715. In step S715, the value of the variable i is incremented by 1, and the flow returns to step S704.

FIG. 8 is a flow chart showing an example of the device response status notification process launched in step S713 in FIG. 7 in the embodiment of the network device management software of the present invention.

Referring to FIG. 8, the presence/absence of a response from the i-th device to be managed in response to the status acquisition request is saved on the RAM 503 in step S714. This data is read out in step S801, and the flow advances to step S802. That is, the previous response result is read out.

In step S802, the presence/absence of a response to the immediately preceding status acquisition request, which is acquired in step S801 for the i-th device to be managed, is checked. If the response to the immediately preceding status acquisition request is present, the flow advances to step S803 (step S802: Yes); otherwise, the flow advances to step S805 (step S802: No).

In step S803, the presence/absence of a response to the latest status acquisition request stored in step S709 or S712 in FIG. 7 for the i-th device to be managed is checked (no response detection step). If no response to the latest status acquisition request is received, the flow advances to step S804 (step S803: Yes); otherwise, this process ends (step S803: No).

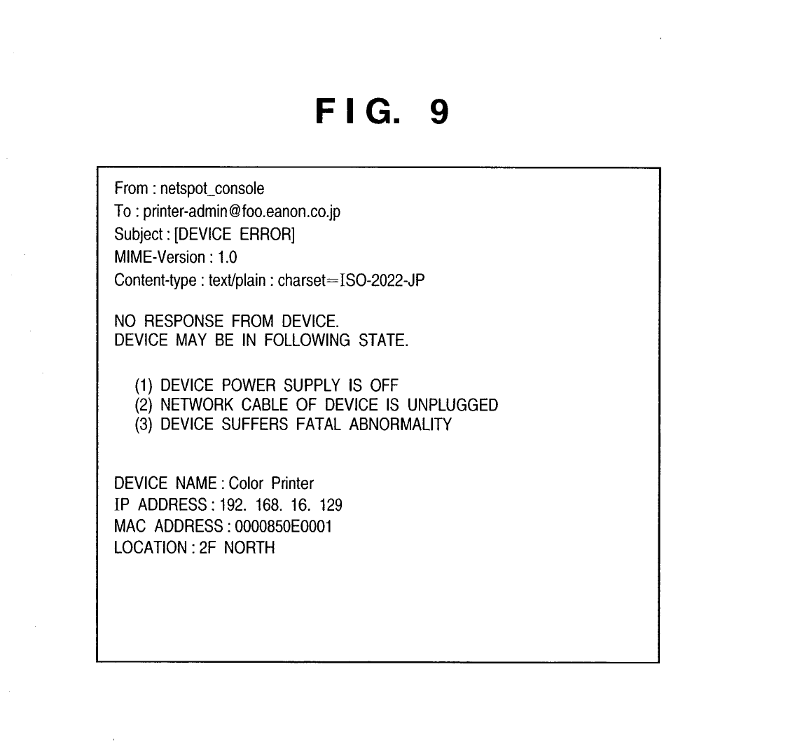

In step S804, an e-mail message indicating that no response is received from the i-th device to be managed is generated (no response mail generation step), and is sent to an address which is set in advance via the e-mail control module 618. The flow then advances to step S807. In this case, an e-mail message having contents shown in, e.g., FIG. 9, is generated.

In step S805, the presence/absence of a response to the latest status acquisition request stored in step S709 or S712 in FIG. 7 for the i-th device to be managed is checked (response recovery detection step). If a response to the latest status acquisition request is received, the flow advances to step S806 (step S805: Yes); otherwise, this process ends (step S805: No).

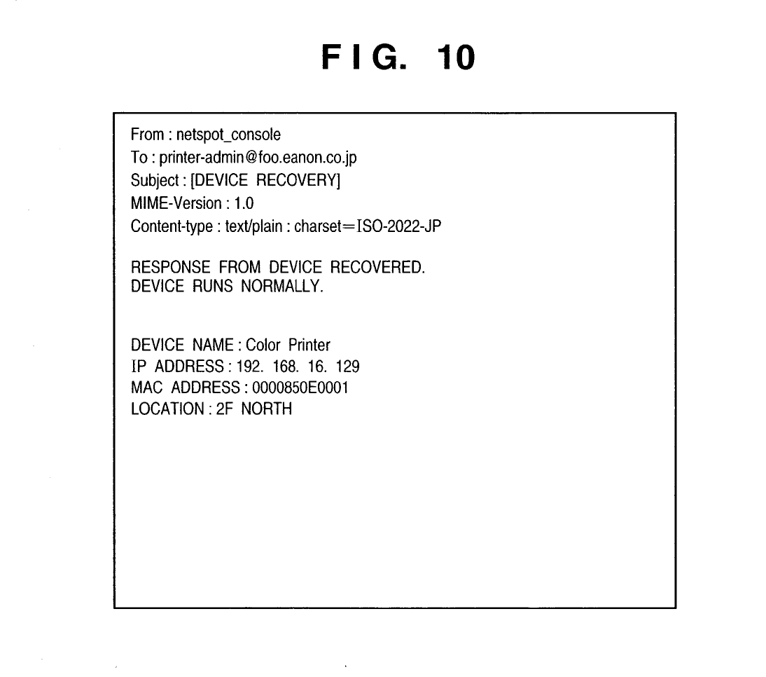

In step S806, an e-mail message indicating that a response from the i-th device to be managed has been recovered is generated (response recovery mail generation step), and is sent to an address which is set in advance via the e-mail control module 618. The flow then advances to step S807. In this case, an e-mail message having contents shown in, e.g., FIG. 10, is generated. In step S807, the e-mail message generated in step S804 or S806 is sent to the address which is set in advance (e-mail sending step), thus ending this process.

In the first embodiment, if it is determined in steps S802 and S805 that no responses are received in two successive information acquisition processes, an e-mail message indicating that no response is received from the device to be managed is not sent.

In the second embodiment, if no responses are received in a plurality of successive processes, the processes in steps S804 and S807 are executed to repetitively send a mail message indicating that no response is received from the device to be managed.

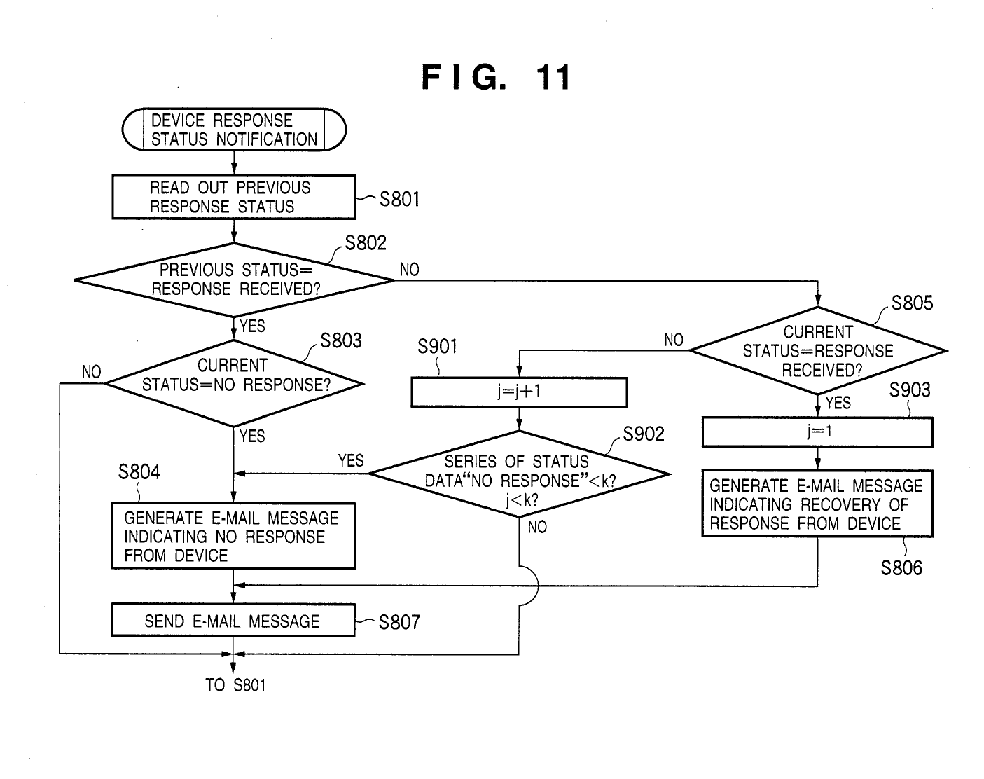

FIG. 11 is a flow chart of the second embodiment. If “no response” in the current process is determined in step S805, the flow advances to step S901. In step S901, the value of a counter j is incremented to count the number of a series of “no responses”. The flow advances to step S902 to compare the value of the counter j with a predetermined threshold value k. If the number of a series of “no responses” is smaller than the predetermined value, the flow advances to step S804 to send an e-mail message indicating no response. Note that the predetermined threshold value k can be arbitrarily set by the user. That is, it is troublesome for the user if he or she receives too many e-mail messages indicating “no response”. Hence, it is practical to set the threshold value k to indicate several times. However, some users may want to receive a “no response” message every time it is detected. In such case, if the threshold value is set to be infinity (in practice, a considerably large value indicating several thousand times), then the flow would always branch from step S902 to step S804 to send a “no response” message every time it is detected. Of course, if “No” in step S805, the flow may directly advance to step S804 without inserting steps S901 to S903. With this flow chart, an e-mail message indicating that no response is received from the device to be managed is periodically sent at device status monitoring cycles (time-out timings of the device monitoring timer launched in step S701 in FIG. 7) until a response from that device to be managed is recovered.

If it is determined in step S805 that a response is received, then since this means that the device has been recovered j is set to 1 to reset the counter. The reason why the initial value of the counter is set to 1 is that No is determined in step S805 when no response was received in the previous process, either.

If it is determined in step S902 that the number of a series of no responses becomes equal to or larger than the predetermined value (j≧k), steps S804 and S807 are skipped, since it is troublesome to receive mail messages any more and the flow returns to step S801 to wait for recovery of the device.

In this way, whether or not a “no response” mail message is sent can be freely set in correspondence with the number of a series of “no responses”.

In the second embodiment, the number of times of sending a “no response” mail message can be freely set. By contrast, in this embodiment, the number of times of sending a “response recovery” mail message can be freely set.

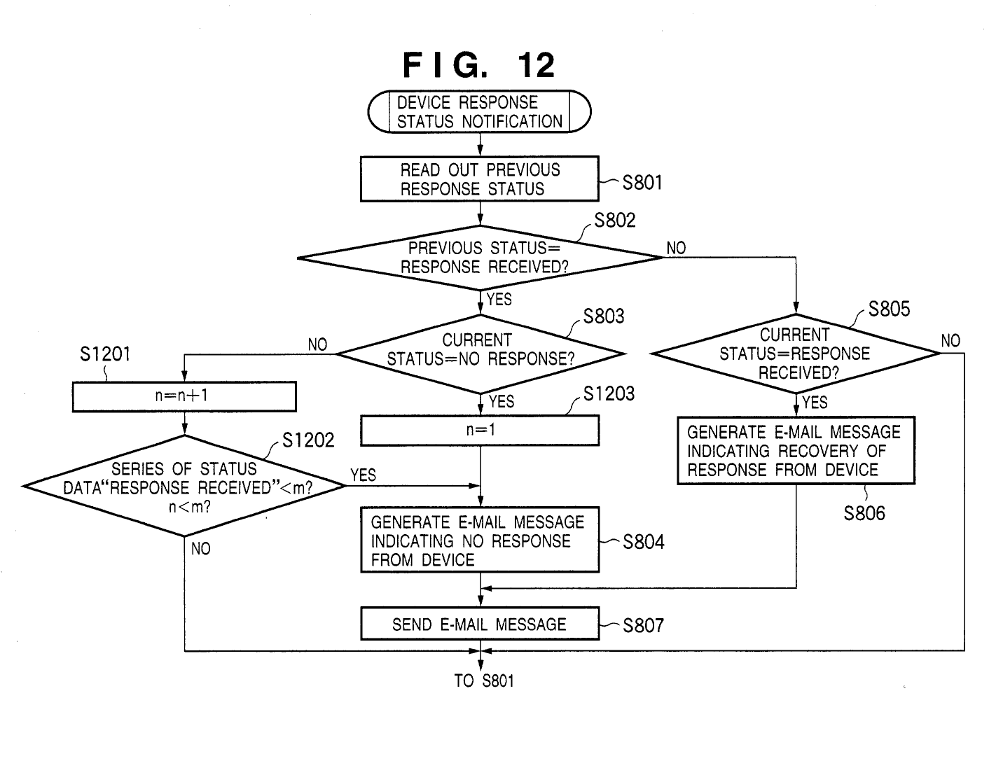

FIG. 12 is a flow chart of this embodiment. If it is determined in step S803 that a response is received in the current process (i.e., a response is also received in the current process), the flow advances to step S1201. In step S1201, a value n of a counter used to count the number of responses received is incremented. Note that the initial value of n is 1 for the same reason as j. It is checked in step S1202 if the number n of times of responses that have been successively received is smaller than m. If n<m, it is determined that the number of times of responses that have been successively received is not so large, and the flow advances to step S804 to generate an e-mail message indicating that a response is received. If n≧m, since no more e-mail messages are sent, the flow returns to step S801 to wait for detection of no response. That is, if it is determined in step S803 that no response is received in the current process, a response from the device is stopped, i.e., the continuity of responses received is disrupted. Hence, the counter n is reset to 1 in step S1203.

The foregoing constitutes the detailed description of the preferred embodiments. These embodiments may be used independently or may be combined appropriately. For example, the second and third embodiments may be combined. In such combination, the numbers of times of “no response” and “response received” messages can be limited at the same time.

Note that the present invention may be applied to either a system or integrated apparatus constituted by a plurality of devices (e.g., a host computer, an interface device, a reader, and the like), or an apparatus consisting of a single piece of equipment.

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. As the storage medium for supplying the program code, for example, a floppy disk, hard disk, optical disk, magneto-optical disk, CD-ROM, CD-R, DVD-ROM, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

Note that the present invention can also be applied to a case wherein a program code of software which is stored in a storage medium and implements the functions of the aforementioned embodiments is distributed to a demander via a communication line of personal computer communications or the like.

When a program is supplied to a computer to implement the present invention, as described above, the process according to the flow chart shown in FIGS. 7, 8, 11, or 12 is implemented by executing the program.

An example of another embodiment will be explained below. As the aforementioned network device management software according to the present invention, an externally installed program, i.e., network device management software is executed by the PC 500. In this case, the present invention can be applied to a case wherein that program is supplied to the PC 500 by loading an information group including the program from a storage medium such as a CD-ROM, flash memory, floppy disk, or the like, or from an external storage medium via an e-mail message or network such as personal computer communications or the like.

FIG. 12 shows the memory map of a CD-ROM as an example of the storage medium. Reference numeral 9999 denotes an area that stores directory information, which indicates the locations of an area 9998 that stores an installation program and an area 9997 that stores network device management software (to be described below). Reference numeral 9998 denotes an area that stores an installation program. Reference numeral 9997 denotes an area that stores network device management software. Upon installing network device management software of the present invention in the PC 500, the installation program stored in the area 9998 that stores the installation program is loaded onto the system, and is executed by the CPU 501. The installation program executed by the CPU 501 reads out network device management software from the area 9997 that stores the network device management software, and stores it in the hard disk 511. In this manner, the network device management software stored in the hard disk 511 is launched at an appropriate timing to practice the present invention.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for managing one or more network devices connected to a network, comprising:
a sending component for controlling a process for sending a response request command to the network device at a predetermined timing;
a detection component for detecting a change in response state of the network device in response to the response request command; and
a message sending component for controlling a process for sending a message corresponding to a detection result of said detection component to a predetermined message address when said detection component detects a change in response state.

2. The apparatus of claim 1, further comprising a message generation component for generating a message corresponding to the detection result of said detection component,
wherein said message sending component controls a process for sending the message generated by said message generation component.

3. The apparatus of claim 1, wherein said detection component detects a change in response state when continuity of responses from the network device to the response request command has changed.

4. The apparatus of claim 3, wherein said detection component detects a change in response state when a response from the network device which sent a response to the response request command is disrupted, and said message generation component generates a message indicating that a trouble has occurred in the network device.

5. The apparatus of claim 3, wherein:
said detection component detects a change in response state when a response is sent from the network device that did not send any response to the response request command;
said message generation component generates a message indicating that the state of the network device has been recovered.

6. The apparatus of claim 1, wherein said detection component further comprises:
a storage component for storing at least one previous response state of the network device; and
a checking component for comparing the previous response state and a current response state, and determining a change in response state when the two response states do not match.

7. An apparatus for managing one or more network devices connected to a network, comprising:
a sending component for sending a response request command to the network device at a predetermined timing;
a receiving component for receiving response information when the network device sends the response information in response to the response request command;
a checking component for checking if said receiving component receives the response information;
a message generation component of generating a message corresponding to the checking result of said checking component to a predetermined message address; and
a message sending component for controlling a process for sending the message generated by said message generation component.

8. The apparatus of claim 7, wherein when said checking component determines that no response information is received, said message generation component generates a message with contents indicating that the network device has ceased to respond.

9. The apparatus of claim 7, wherein:
said sending component sends the response request command even to the network device which has ceased to respond;
said checking component checks if the response information is sent from the network device which has ceased to respond to the response request command, and is received by said receiving component;
when said checking component determines that the response information begins to be received again, said message generation component generates a message with contents indicating that the network device has been recovered.

10. The apparatus of claim 7, further comprising:
a storage component for time-serially storing checking results of said checking component; and
a detection component for detecting a change between time-serial first and second checking results which are stored by said storage component,
wherein when said detection component detects a change, said messagegeneration component generates a message with contents corresponding to the change.

11. The apparatus of claim 7, further comprising:
an accumulation component for accumulating at least a previous one of checking results of said checking component; and
a detection component for detecting a change between a previous checking result (first checking result) accumulated by said accumulation component, and a current checking result (second checking result),
wherein when said detection component detects a change, said message generation component generates a message with contents corresponding to the change.

12. The apparatus of claim 10, wherein said message generation component generates a message with contents indicating that the network device has ceased to respond when said detection component detects that the first checking result indicating that the response information was received has changed to the second checking result indicating that no response information is received.

13. The apparatus of claim 10, wherein when said detection component detects that the first checking result indicating that no response information was received has changed to the second checking result indicating that the response information is received,
said message generation component generates a message with contents indicating that the network device has been recovered.

14. The apparatus of claim 7, wherein the response information contains information that pertains to a state of the network device.

15. The apparatus of claim 7, wherein the predetermined timing includes a periodic timing.

16. The apparatus of claim 1, wherein said message is e-mail message.

17. A method for managing one or more network devices connected to a network, comprising the steps of:
sending a response request command to the network device at a predetermined timing;
detecting a change in response state of the network device in response to the response request command; and
controlling a process for sending a message corresponding to a detection result of the detection step to a predetermined message address when a change in response state is detected in the detection step.

18. The method of claim 17, further comprising the step of generating a message corresponding to the detection result of the detection step,
wherein the message sending step includes the step of controlling a process for sending the message generated in the message generation step.

19. The method of claim 17, wherein the detection step includes the step of detecting a change in response state when continuity of responses from the network device to the response request command has changed.

20. The method of claim 17, wherein:
the detection step includes the step of detecting a change in response state when a response from the network device which sent a response to the response request command is disrupted; and
the message generation step includes the step of generating a message indicating that a trouble has occurred in the network device.

21. The method of claim 19, wherein:
the detection step includes the step of detecting a change in response state when a response is sent from the network device that did not send any response to the response request command; and
the message generation step includes the step of generating a message indicating that the state of the network device has been recovered.

22. The method of claim 19, wherein the detection step further comprises the steps of:
storing at least one previous response state of the network device; and
comparing the previous response state and a current response state, and determining a change in response state when the two response states do not match.

23. A method for managing one or more network devices connected to a network, comprising the steps of:
sending a response request command to the network device at a predetermined timing;
receiving response information when the network device sends the response information in response to the response request command;
checking if the response information is received in the reception step;
generating a message corresponding to the checking result of the checking step to a predetermined message address; and
controlling a process for sending the message generated in the message generation step.

24. The method of claim 23, wherein the message generation step includes the step of, generating a message with contents indicating that the network device has ceased to respond when it is determined in the checking step that no response information is received.

25. The method of claim 24, wherein:
the sending step includes the step of controlling a process for sending the response request command even to the network device which has ceased to respond;
the checking step includes the step of checking if the response information is sent from the network device which has ceased to respond to the response request command, and is received in the reception step; and
the message generation step includes the step of, when it is determined in the checking step that the response information begins to be received again, generating a message with contents indicating that the network device has been recovered.

26. The method of claim 23, further comprising the steps of:
time-serially storing checking results of the checking step; and
detecting a change between time-serial first and second checking results which are stored in the storage step,
wherein the message generation step includes the step of, generating a message with contents corresponding to the change when a change is detected in the detection step.

27. The method of claim 23, further comprising the steps of:
accumulating at least a previous one of checking results of the checking step; and
detecting a change between a previous checking result (first checking result) accumulated in the accumulation step, and a current checking result (second checking result),
wherein the message generation step includes the step of, when a change is detected in the detection step, generating a message with contents corresponding to the change.

28. The method of claim 26, wherein the message generation step includes the step of, generating a message with contents indicating that the network device has ceased to respond when it is detected in the detection step that the first checking result indicating that the response information was received has changed to the second checking result indicating that no response information is received.

29. The method of claim 26, wherein the message generation step includes the step of, generating a message with contents indicating that the network device has been recovered when it is detected in the detection step that the first checking result indicating that no response information was received has changed to the second checking result indicating that the response information is received.

30. The method of claim 23, wherein the response information contains information that pertains to a state of the network device.

31. The method of claim 23, wherein the predetermined timing includes a periodic timing.

32. The method of claim 17, wherein said message is e-mail message.

33. A computer program product for managing one or more network devices connected to a network, said computer program product comprising:
a computer-readable medium; and
computer-executable instructions carried on said computer-readable medium for performing the steps of:
sending a response request command to the network device at a predetermined timing;
detecting a change in response state of the network device in response to the response request command; and
controlling a process for sending a message corresponding to a detection result of the detection step to a predetermined message address when a change in response state is detected in the detection step.

34. A computer program product for managing one or more network devices connected to a network, said computer program product comprising:
a computer-readable medium; and
computer-executable instructions carried on said computer-readable medium for performing the steps of:
sending a response request command to the network device at a predetermined timing;
receiving response information when the network device sends the response information in response to the response request command;
checking if the response information is received in the reception step;
generating a message corresponding to the checking result of the checking step to a predetermined message address; and
controlling a process for sending the message generated in the message generation step.

35. A program for managing one or more network devices connected to a network, the program is embodied in a recording medium and comprising:
a sending program component for controlling a process for sending a response request command to the network device at a predetermined timing;
a detection program component for detecting a change in response state of the network device in response to the response request command; and
a message sending program component for controlling a process for sending a message corresponding to a detection result of said detection program component to a predetermined message address when said detection component detects a change in response state.

36. A program for managing one or more network devices connected to a network, the program is embodied in a recording medium and comprising:
a sending program component for sending a response request command to the network device at a predetermined timing;
a receiving program component for receiving response information when the network device sends the response information in response to the response request command;
a checking program component for checking if said receiving component receives the response information;
a message program generation component of generating a message corresponding to the checking result of said checking program component to a predetermined message address; and
a message sending program component for controlling a process for sending the message generated by said message generation program component.
